(19) United States
(12) Patent Application Publication
(10) Pub. No.: US 2008/0260988 A1
(43) Pub. Date: Oct. 23, 2008

(54) Method for Stabilizing a Pile Fabric Such as Pile Carpet with a Reinforcing Back and Web According to the Method

(76) Inventors: Manfred Aulbach, Momlingen (DE); Dieter G. Suchy, EJ Goirle (NL)

Correspondence Address: K.F. ROSS P.C., 5683 RIVERDALE AVENUE, SUITE 203 BOX 900, BRONX, NY, 10471-0900, US

(21) Appl. No.: 11/663,083

(22) PCT Filed: Sep. 11, 2004
(86) PCT No.: PCT/EP04/52896

§ 371 Date: Feb. 19, 2008

(30) Foreign Application Priority Data
Sep. 16, 2004 (DE) 10 2004 045 282.2

(51) Int. Cl. D05C 17/02; D05C 15/04

(52) U.S. Cl. 428/95; 156/72

(57) ABSTRACT

A conventional method for producing pile carpet, e.g. pile carpet whose pile fibers are tufted into a support layer, consists in providing the back side of the support layer with a non-woven and in linking said nonwoven with the support layer and with the dorsal fibers of the pile fibers by hydrodynamic needle-punching. The aim of the invention is to provide the support layer with a back of its own which preferably consists of a fusible fiber. The support layer may also contain said fibers. The pile fibers are tufted into the composite support layer, the back of the intermediate product is covered with an additional fleece which consists preferably of the fusible fibers, all the components are hydrodynamically needle-punched, and the product is heat-treated in order to melt the fibers.

A method is known from EP-A-1 081 263 for continuous stabilization of a pile carpet, tufted carpet, pile goods, or the like, in any case of an elongated web having a face side that must not be changed in terms of its structure and quality, and a rear backing layer to which the pile-forming yarns are applied and then anchored because the pile yarns were only added in an unstable manner, e.g. tufted, to the backing layer made of e.g. a spun-bonded fabric made of polyester yarns, a woven fabric, or a knit fabric, in any case for anchoring in the backing layer the pile yarns, which are only loosely held in the backing layer, by means of hydrodynamic water needling.

This method is of particular significance for the recyclability of a carpet. In the future the foam back/secondary backing, commonly made of latex in the past, for stabilizing the pile fibers will no longer be necessary.

Prior to this development it was known to spray the back side of a carpet, the back side of the backing layer with the pile fibers attached there by means of a hot melt powder (EP-A-0 005 050). However, this method did not lead to success because it was not possible to bond the powder with the backing layer adequately. The same applies when, instead of a powder, a fusible fiber (DE-A-195 06 845) or a fusible film (DE-A-43 41 168) is applied. It was not possible to attain a more intensive bonding of the back fibers to the backing layer using these methods. Pressing did not help. either, simply because the pile fibers could not be subjected to a pressure that was too high.

Furthermore, it is known from DE-A-42 44 173 to join the textile secondary backing, called the nonwoven, to the backing layer by means of an intermediate fleece. This intermediate fleece should at least partially comprise thermoplastic fibers that then by are intended to fuse and effect a better bonding of the pile fibers to the backing layer. The above-described disadvantage applies in the same manner here, as well. DE-A-100 56 180 discloses another development according to which the secondary backing together with the intermediate layer are intended to be joined to the backing layer by means of hydrodynamic needling.

None of these methods led to the desired result simply because it was not possible to attain adequate intermingling of the components of the joining layer such as the intermediate layer to the e.g. tufted back components of the pile fibers and to the fibers of the backing layer.

Proceeding from the method in accordance with EP-A-1 081 263, the underlying object of the invention is to attain further improvement in the bonding of the pile fibers to the backing layer using a supplementary method. For this, the invention provides that initially the previously known backing layer is securely joined to a fleece made of a synthetic fiber and/or other fibers such as natural fibers, also, or the backing layer comprises these fibers at least in part, such a composite backing layer is then provided with the pile fiber to create the intermediate product, such as is tufted, and specifically such that in an additional fleece layer the latter is arranged on what will later be the back side of the carpet, then the back of this intermediate product is covered with another back fleece made of the same or a similar fiber as that of the composite backing layer, the back fleece is joined securely, by means of continuous dynamic needling, to at least the back side of the intermediate product to create the provisional final product, and finally the carpet is subjected to a heat treatment.

The reason for this measure is to attain better mixing of the fibers holding the pile in the backing layer. Now the backing layer, which initially is intended to produce a dimensionally stable carpet back, has a new, securely adhering back made of a fleece, the fibers of which are intended to bond to the fibers of the actually bonding back. The back, the fleece of the backing layer, is at least partially made of the same fibers as the fleece back to be needled thereto. In another example, the backing layer can comprise, at least in part, the new fibers, as well as a few antistatic fibers for reducing electrostatic charge, that is, it is not necessary for a back fleece made of the additional fibers to cover the backing layer; the backing layer can also contain these necessary fibers. During the continuous dynamic needling, these fibers then mix and thus enclose and fix the roots of the pile fibers.

A better product is obtained when the fibers used from the fleece or, better, the fleeces, or the backing layer itself comprise(s) at least in part synthetic fibers that fuse below at most 120° C. as well as bicomponent fibers and the back is needled to the intermediate product by means of hydrodynamic needling. If this provisional final product is then dried and heated such that the fusible fibers, hooked to one another, of the two back layers fuse and join and adhere to one another, then adequate fixing of the pile fibers is also attained in the backing layer, in the composite backing layer.

One special advantage of the method in accordance with the invention is attained when, during the preferably hydrodynamic needling, the fibers of the two back layers or where required also fiber components of the backing layer travel between the fibers of the pile. There these ends of the fibers can form a support for the actual pile fibers. This applies even more when the preneedled ends of the fibers comprise fusible fibers that when fused can produce even better support for the pile fibers. Using the holding of the pile fibers in the foot region of the pile fibers by means of the fiber ends preneedled in this area, the ability of the pile fibers that have been compressed during use to stand up again is positively supported.

A new product is produced using the method, specifically a web comprising a pile added as known to a backing layer and comprising a back layer, additionally anchored to the back of the backing layer and the pile by means of hydrodynamic needling, in which now however the back side of the backing layer is joined to a fleece, the fibers of which preferably comprise fusible fibers that fuse up to 120° C. for holding the pile fibers in the backing layer. However, the backing layer itself can also contain or comprise these fusible fibers. As is known, the pile fibers are added to this sandwich backing layer, however the back of the intermediate product is then also covered with a fleece made preferably of fibers that fuse up to 120° C., and this is joined to the fibers of the composite backing layer by hydrodynamic needling. With this, it is essential that the fibers of the temporary carpet back are intermingled with the same fibers of the fleece back of the backing layer for the pile fibers.

1-20. (canceled)

21. A method of making a pile web usable as carpet, the method comprising the step of sequentially:
forming a backing layer at least partially as a fiber fleece;
tufting yarns to the backing layer such that the yarns project to a front side and are exposed on a back face of the backing layer;
applying over the exposed yarns on the back face of the backing layer a backing fleece of substantially the same fibers as the fiber fleece of the backing layer;
hydrodynamically needling the backing fleece to the backing layer and the yarns exposed on the back face of the backing layer; and
heat treating the needled backing fleece and backing layer.

22. The method defined in claim 21 wherein the fiber fleece of the backing layer and the backing fleece are comprised at least partially of filaments fusible up to at most 120° C.

23. The method defined in claim 22 wherein the filaments of the backing layer and backing fleece are synthetic.

24. The method defined in claim 22 wherein the filaments of the backing layer and backing fleece are a mixture of synthetic and natural fibers.

25. The method defined in claim 22 wherein the filaments of one of the fleeces includes antistatic filaments.

26. The method defined in claim 21 wherein during hydrodynamic needling filaments of the fleeces are pushed through past a front face of the backing layer and there support the yarns.

27. The method defined in claim 26 wherein during heat treating the filaments pushed past the front face are fused to the yarns.

28. A pile web comprising:
a backing layer formed at least partially as a fiber fleece;
pile yarns tufted to the backing layer such that they project to a front side and are exposed on a back face of the backing layer;
a backing fleece of substantially the same fibers as the fiber fleece of the backing layer applied over the exposed yarns on the back face of the backing layer, the fibers of the backing fleece being hydrodynamically needled to the backing layer and the yarns exposed on the back face of the backing layer; and
fused bonds between the needled backing fleece and the backing layer.
